(19) United States
(12) Patent Application Publication
(10) Pub. No.: US 2014/0167460 A1
(43) Pub. Date: Jun. 19, 2014

(54) Control Element for a Vehicle Seat

(71) Applicant: Continental Automotive GmbH, Hannover (DE)

(72) Inventors: Markus Prexl, Schierling (DE); Andreas Foistner, Thalmaessing (DE); Alexander Selhorst, Ingolstadt (DE)

(21) Appl. No.: 14/011,890

(22) Filed: Aug. 28, 2013

(30) Foreign Application Priority Data
Aug. 29, 2012 (DE) 102012215301.2

(51) Int. Cl. B60N 2/44

(52) U.S. Cl. CPC B60N 2/4415
USPC 297/217.1; 156/60; 156/145; 297/284.1

(57) ABSTRACT

A control element for a vehicle seat includes a bladder configured to be filled with a pressure medium and which includes first and second films connected together along a connecting seam to form a bladder chamber. The connecting seam may have a shape of a polygon, e.g., a square or rectangle, with rounded corners, wherein the sides connecting the corners are curved in a concave manner toward the interior of the polygon. The shape of the connecting seam and thus the shape of the resulting bladder chamber may prevent or reduce the occurrence of constrictions and/or kinks when filling the bladders, which may ensure a reliable and durable operation of the control element.

### CROSS-REFERENCE TO RELATED APPLICATIONS

This application claims priority to DE Patent Application No. 10 2012 215 301.2 filed Aug. 29, 2012. The contents of which are incorporated herein by reference in their entirety.

### TECHNICAL FIELD

The present invention relates to a control element for a seat of a vehicle, in particular a motor vehicle, as well as a vehicle seat having at least one control element for altering a contour of a seat surface. The invention further relates to a method for producing an aforementioned control element.

### BACKGROUND

In modern vehicles, bladders which are able to be filled with a pressure medium, in particular with compressed air, and which may be supplied with pressure medium via one respective pressure medium line, are located in a region of the seat surface and/or backrest (denoted as a whole as the seat support surface). By filling one respective bladder with pressure medium, the volume thereof is increased so that as a result the properties of a backrest and/or seat surface are able to be altered in contour. For filling the bladders with pressure medium, said pressure medium is initially produced by a pressure source, for example by a compressor, and conducted to one respective bladder via a corresponding valve, in particular an electro-pneumatic valve.

In this case, such bladders for adjusting the contour of a seat support surface in the function of a control element may be designed as shown in FIGS. 1A and 1B. In this case, a control element SE0 for altering a seat support surface has a double bladder DBL0, as shown in FIG. 1B, comprising a first bladder B01 and a second bladder B02 connected to said first bladder. Each bladder includes two films which are sealingly connected together at a corresponding connecting seam V01 and/or V02, so that the first bladder B01 has a first bladder chamber BLK01 and the second bladder B02 has a second bladder chamber BLK02 which are able to be filled with a pressure medium (pressure medium). Whilst the empty state of the double bladder DBL0 is shown in FIG. 1A, in the view in FIG. 1B, pressure medium is pumped into the two bladders via a compressed air line BL0. By filling the bladders with compressed air, the volume thereof increases, in particular in a direction D, i.e. a direction perpendicular to the connecting planes through the connecting seams V01 and/or V02.

As visible in FIG. 1A, in a plan view of a connecting plane which is provided by the respective connecting seams, the respective bladders have a square shape with slightly outwardly curved side lines. In other words, the respective connecting seams have a square shape in which the respective corners E0 are connected together via side lines S0 curved in a slightly convex manner relative to a center Z. If bladders shaped in this manner are pumped up with pressure medium, kinks KN are produced as is visible in FIG. 1B. Such kinks lead to considerable stress of the films of the bladders and generally lead to premature failure of a bladder and/or double bladder and may lead to a malfunction of the entire seat comfort function.

### SUMMARY

One embodiment provides a control element for a vehicle seat having the following features: a bladder which is able to be filled with a pressure medium and which includes at least one first and one second film which are connected together along a connecting seam in order to form a bladder chamber, wherein the connecting seam has the shape of a polygon with rounded corners and wherein the sides connecting the corners are curved in a concave manner.

In a further embodiment, the connecting seam is configured as a polygon in the shape of a square or a rectangle.

In a further embodiment, the control element also has a pressure medium line for introducing the pressure medium into the bladder chamber, wherein the pressure medium line is incorporated between the at least one first and second film at the connecting seam.

In a further embodiment, the pressure medium line is incorporated in the bladder chamber perpendicular to a tangent applied to a point of the connecting seam.

In a further embodiment, the control element also has a pressure medium orientation device for orientating the pressure medium flow when the pressure medium enters the bladder chamber, wherein the pressure medium orientation device is designed to orientate the pressure medium flow away from the center of the bladder.

In a further embodiment, the control element also has a further bladder which is able to be filled with pressure medium and which is connected to the bladder via an overflow channel which originates from a bladder portion of the first bladder.

In a further embodiment, the further bladder corresponding to the bladder includes at least one first and one second film which are connected together along a connecting seam in order to form a bladder chamber, wherein the connecting seam has the shape of a polygon with rounded corners and wherein the sides connecting the corners are curved in a concave manner.

In a further embodiment, the connecting seam is a welded seam.

In a further embodiment, the bladder is able to be filled with a gaseous pressure medium, in particular air.

Another embodiment provides a vehicle seat having the following features: a seat support surface for a user; and at least one control element as claimed in one of the preceding claims which is arranged in the vehicle seat in order to alter the contour of the seat support surface.

Another embodiment provides a method for producing a control element for a vehicle seat having the following steps: providing at least one first and one second film; and connecting the at least one first and second film together at a connecting seam such that a bladder chamber is formed between the films, wherein the connecting seam has the shape of a polygon with rounded corners and wherein the sides connecting the corners are curved in a concave manner.

In a further embodiment, the pressure medium line, via which a pressure medium is able to be introduced into the bladder chamber, is arranged between the at least one first and one second film.

### BRIEF DESCRIPTION OF THE DRAWINGS

Example embodiments of the present invention are described in more detail below with reference to the drawings, in which:

FIGS. 1A and 1B show a control element with a double bladder, resulting in kinks and constrictions when filled;

FIG. 2 shows a schematic sectional view of an individual bladder according to a first embodiment;

FIG. 3 shows a plan view of the bladder shown in FIG. 2;

FIG. 4 shows a sectional view of a multiple bladder as control element (in the empty state) according to a second embodiment;

FIG. 5 shows a perspective view from above and the side of the multiple bladder of FIG. 4 in the filled state;

FIG. 6 shows a schematic view of a vehicle seat with a plurality of control elements, for example according to the embodiments shown above.

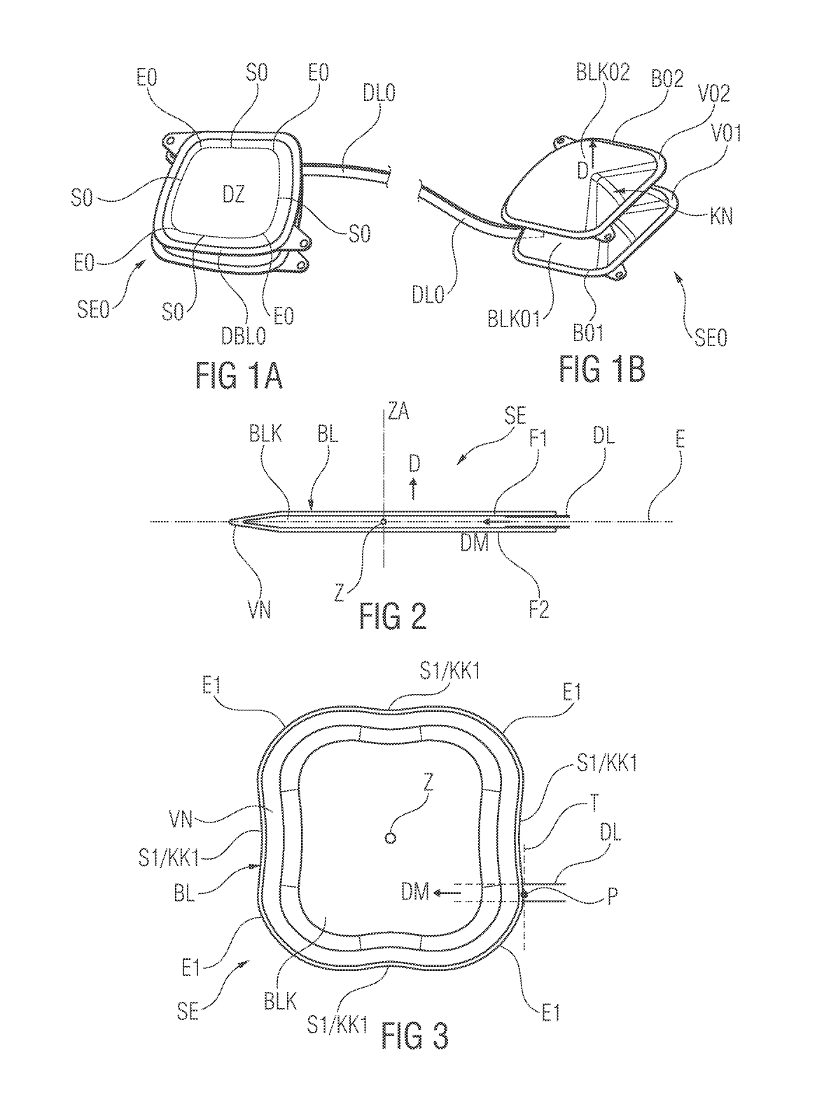

### DETAILED DESCRIPTION

Embodiment of the present invention provide a reliable and durable operation of a control element for a vehicle seat.

In one embodiment, a control element (or even a lifting element) for a vehicle seat, in particular a motor vehicle seat, has the following features. Said control element has a bladder which is able to be filled with a pressure medium and which includes at least one first and one second film which are connected together along a connecting seam in order to form a bladder. In particular the at least one first and one second film are connected in a plane along a peripheral connecting seam, so that between the films a space (and/or a chamber) is produced which is able to be filled with pressure medium, which expands when filled with pressure medium in a direction perpendicular to the plane and thus effects a lifting of the upper film and the lower film away from the plane. In this case, the at least one first film and one second film are respectively separate films or even corresponding portions of a single film. Moreover, the connecting seam is configured in the form of a polygon with rounded corners, wherein the sides connecting the corners are curved in a concave manner (in the direction of the interior of the polygon). By such a shape of the bladder and/or bladder chamber, a uniform filling of the bladder chamber may be achieved so that the production of kinks in a film is prevented. In this manner, the life of the bladder may be increased and the risk of malfunction is minimized.

According to one embodiment, the connecting seam may have the shape of a square or rectangle with rounded corners and sides which connect the corners and which are curved in a concave manner.

According to a further embodiment, the control element has a pressure medium line for introducing the pressure medium into the bladder chamber, wherein the pressure medium line is incorporated between the at least one first and second film at the connecting seam. For a stable arrangement of the pressure medium line, said line may be incorporated in the bladder chamber perpendicular to a tangent applied to a point of the connecting seam. For example, the pressure medium line may have a linear portion and/or tubular portion which is guided into the bladder chamber perpendicular to a tangent applied to a point of the connecting seam.

According to a further embodiment, the control element may also have a pressure medium orientation device for orientating the pressure medium flow when the pressure medium flows into the bladder chamber, wherein the pressure medium orientation device is designed to orientate the pressure medium flow away from the center of the bladder. In particular, the pressure medium orientation device may be designed to orientate the pressure medium flow along an inner wall of the bladder chamber. Such an orientation of the pressure medium flow and/or the pressure medium inflow into the bladder reduces the production of turbulent flows when filling the bladder chamber and thus also flow noise associated therewith. In this case, when the bladder chamber is filled, the bladder chamber wall opposing the pressure medium inlet is prevented from being directly sprayed against. By this reduction in flow noise when the pressure medium flows into a bladder of the control element, the comfort when operating the control element which is frequently actuated, in particular within the context of a massage program, is thus also considerably increased and achieves greater user acceptance.

In a further embodiment of the control element, the pressure medium orientation device may be formed from an end portion of the pressure medium line. In this case, said end portion of the pressure medium line, in particular, may also protrude into the bladder chamber. By combining said two elements of the pressure medium orientation device and the pressure medium line, therefore, the technical complexity of the control element and thus also the costs are minimized.

In an embodiment of this combination described above of the pressure medium orientation device and the pressure medium line, the pressure medium line may have a linear end portion which is incorporated in the connecting seam such that the pressure medium flow (from said linear end portion as the pressure medium orientation device) is oriented away from the center of the bladder chamber. Thus, on the one hand, the technical complexity of combining two elements and the production cost of the entire control element are minimized as the pressure medium orientation device is able to be implemented simply by specifically welding-in the pressure medium line.

Moreover, according to a further embodiment of the above-mentioned pressure medium line with the pressure medium orientation device, it is conceivable that the pressure medium line has an angled end portion which is arranged in the bladder chamber for diverting the pressure medium flow (away from the center of the bladder chamber). Thus, once again, in addition to reducing the technical complexity by combining two elements, the production cost is also further minimized as the pressure medium line may be incorporated in the connecting seam in almost any manner and the pressure medium flow is diverted instead by the angled end portion.

According to a further embodiment, the control element also has a further bladder which is able to be filled with pressure medium and which is connected to the (first) bladder via an overflow channel which originates from a bladder portion of the (first) bladder. In this case the overflow channel may be arranged such that it originates from a bladder portion of the (first) bladder, through which an axis passes, extending perpendicular to a connecting seam plane and through the center of the (first) bladder.

According to an embodiment of this arrangement of a control element with more than one bladder, corresponding to the first bladder, the further bladder may include at least one first and one second film which are connected together along a connecting seam in order to form a bladder chamber, wherein the connecting seam has the shape of a polygon with rounded corners, corresponding to the (first) bladder and wherein the sides connecting the corners are curved in a concave manner (relative to the inside of the further bladder). Advantageously, the (first) bladder and the further bladder have the same basic shape (the same shape relative to the connecting seam) and are arranged in a congruent manner on top of one another. In this manner, a compact control element with a large actuating and/or lifting path may be achieved.

It should be mentioned that the control element may also have more than the two aforementioned bladders, for example three or more bladders which, in particular as already described above, have the same basic shape and (in particular in the empty state) are arranged in a congruent manner on top of one another in order to permit a compact design of the control element in the empty state but providing a large actuating path and/or lifting path during the filling process.

According to a further embodiment of the control element, the connecting seam is configured, in particular, as a welded seam. A connecting seam in the form of an adhesively bonded seam is, however, also conceivable. Advantageously, however, the welded seam is produced by means of high frequency welding. In particular by means of the welding, very stable and durable connections may be produced between the two films of the (respective) bladder.

According to a further embodiment of the control element, the (respective) bladder is able to be filled with a gaseous pressure medium, in particular air. In this manner, the bladder and/or bladder chamber may be filled in a simple and cost-effective manner. For producing a cost-effective control element, it is also possible to produce the at least one first or second film of the respective bladder(s) from plastics material.

According to a further embodiment, a vehicle seat, in particular a motor vehicle seat, may include the following features. Said seat has a seat support surface (in the form of a seat surface and/or a backrest), wherein in the region of said seat support surface in the seat at least one control element is provided according to an embodiment shown above and/or an embodiment thereof, which is arranged in the vehicle seat in order to alter the contour of the seat support surface. In particular, such an alteration to the contour of said seat support surface may be used as a comfort function for a user within the context of a massage program. Primarily within the context of a massage function in which the control element is frequently actuated, the user comfort is increased and a long service life is ensured due to the greater kink stability of the bladder.

According to a further embodiment, a method is provided for producing a control element for a vehicle. In this case, initially at least one first and one second film are provided. Subsequently, the at least one first film and second film are connected together at a connecting seam such that a bladder chamber is formed between the films, wherein the connecting seam has the shape of a polygon with rounded corners and wherein the sides connecting the corners are curved in a concave manner (in the direction of the inside of the polygon). Due to this selected contour of the connecting seam, an increase in the kink stability of the bladder is achieved so that the probability of a constriction and/or a kink when filling the bladder with pressure medium is minimized.

According to one embodiment, after providing the at least one first and one second film, a pressure medium line is arranged between the two films. Then the at least one first film and second film are connected together at the connecting seam such that between the two films the bladder chamber is formed, into which bladder chamber a pressure medium may be introduced via the pressure medium line.

In this case, embodiments of the control element, insofar as they may be applied to the vehicle seat and to the method, are regarded as embodiments of the vehicle seat and the method and vice versa.

Initially reference is made to FIG. 2, in which a schematic cross-sectional view of a control element SE for a vehicle seat, in particular a motor vehicle seat, is shown according to a first embodiment. In this case, the control element SE comprises a bladder BL which in this case is formed from two films F1 and F2. The films in this case may be configured, in particular, from plastics material. As shown on the left-hand side of the figure, the two films F1 and F2 are connected together by a material connection at a connecting seam VN. In this case, the connecting seam may be configured, in particular, as a welded seam. By connecting the two films F1 and F2 (via the connecting seam VN), a bladder interior and/or a bladder chamber BLK is produced which is able to be filled with a pressure medium DM, in particular air. The pressure medium DM may in this case be introduced into the bladder chamber via a pressure medium line DL. In this case, the pressure medium line DL is arranged between the two films F1 and F2 and incorporated in the connecting seam VN such that a bladder chamber BLK which is sealed against pressure medium is produced. It is also possible that the pressure medium DM is able to be discharged again from the bladder chamber BLK via the pressure medium line DL.

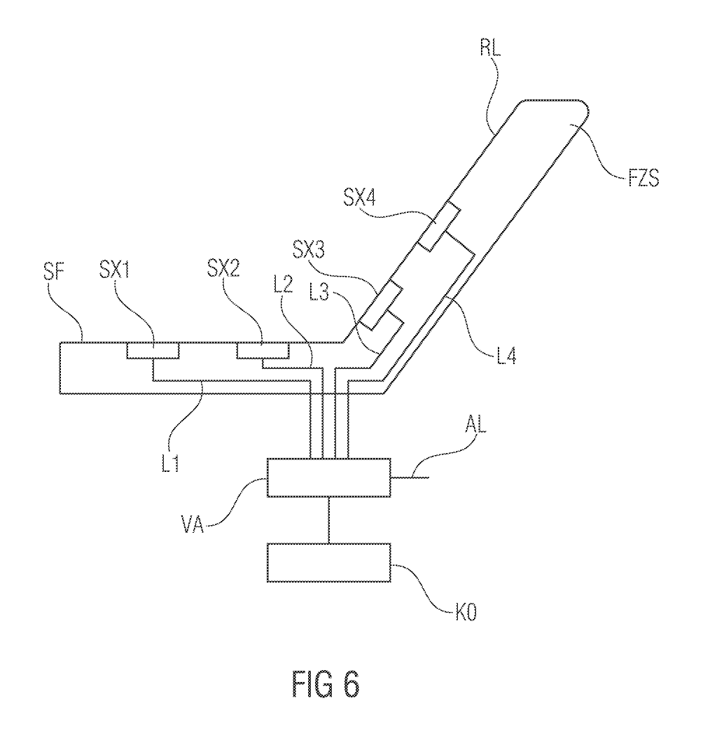

With the assumption that, for example, the bladder BL is arranged with its second film F2 on a fixed substrate, the bladder BL is altered in shape when filled with pressure medium and the film F1 moves in the direction of the arrow D, so that a pressure is able to be exerted by means of the control element SE in the direction of the arrow D upwards in the figure. This specific provision of pressure in this case may be used in a vehicle seat in which a control element is provided in the seat below a seat support surface, so that the contour of the seat support surface is able to be altered at the location of the control element (as for example is subsequently described further with reference to FIG. 6). As is more clearly visible with reference to FIG. 3, the center Z of the bladder is located in the middle of the bladder BL, wherein an axis ZA is provided through this center Z perpendicular to the plane E of the bladder and/or the peripheral connecting seam VN.

Reference is now made to FIG. 3 in which a schematic plan view is shown of the bladder shown in FIG. 2 according to the first embodiment in a viewing direction of the axis ZA onto the plane E (see FIG. 2). Once again, the control element SE is formed from the bladder BL which is able to be filled with pressure medium DM by means of the pressure medium line DL.

The characterizing feature of the bladder of FIG. 3 is the shape thereof, in particular the shape of the connecting seam VN and/or the path thereof. The connecting seam in this case has the shape of a rectangle, in the example here the shape of a square which has rounded corners E1, which are connected via side lines S1 which are curved in a concave manner relative to the interior of the rectangle/square (and thus in the direction of the inside of the bladder). This means that the respective side lines S1 have a concave portion KK1 (at the point where the reference arrow ends). As is shown subsequently with reference to a filled double bladder in FIG. 5, also in a single bladder shown in FIG. 3, by means of the shape and/or contour of the connecting seam the bladder chamber BLK may be filled uniformly and a constriction and/or kinking of the films forming the bladder BL may be prevented.

According to a particular embodiment of the control element according to FIG. 3, the pressure medium line DL is incorporated between the two films so that a linear portion of the pressure medium line (shown in dashed lines within the bladder) is introduced into the bladder chamber perpendicular to a tangent T applied to a point P of the connecting seam. Thus, a stable connection of the pressure medium line is achieved inside the connecting seam. Moreover, the pressure medium line is incorporated in the connecting seam VN such that the pressure medium flow is oriented away from the center Z when the pressure medium flows into the bladder chamber. Instead, the pressure medium flow is oriented along an inner wall of the bladder chamber BLK in order to avoid turbulent flows in the bladder and to prevent flow noise when filling the bladder.

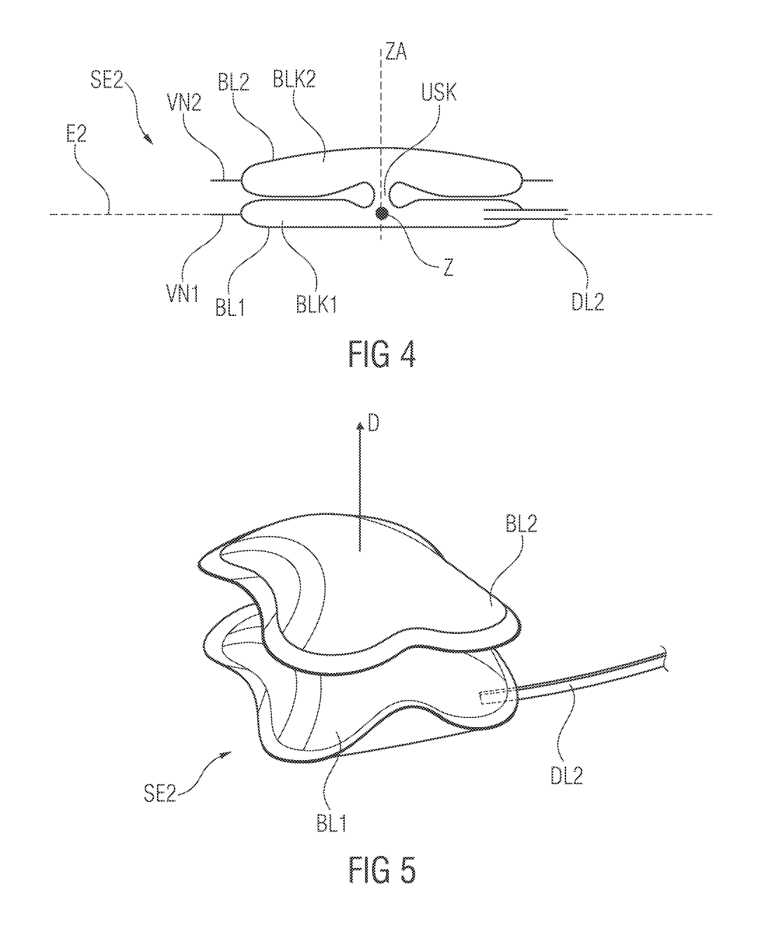

Reference is now made to FIG. 4, in which a schematic cross-sectional view of a control element SE2 according to a second embodiment is shown. The characterizing feature of this second embodiment is that the control element in this case has a multiple bladder (in place of an individual bladder, as in the previous embodiment). As visible in FIG. 4, the control element SE2 has a first bladder and/or lower bladder BL1 which includes two films, as in the embodiment shown above, and which are connected together via a first connecting seam VN1 (in particular a welded seam) in order to form a first bladder chamber BLK1, which is able to be filled with a pressure medium. Moreover, the control element SE2 has a second or upper bladder BL2 also in turn including two films (or film layers) which are connected together via the second connecting seam VN2 (in particular a welded seam), in order to form a second bladder chamber BLK2 which is also able to be filled with a pressure medium. The two bladders BL1 and BL2 in the view of FIG. 4 are in an empty state i.e. they are not filled with pressure medium.

As may also be seen in FIG. 4, the two bladders BL1 and BL2 are connected together via an overflow channel USK. Said overflow channel extends along an axis ZA which, in particular, passes through the center Z of the first bladder BL1 (and also the second bladder BL2). In particular, it is assumed therefrom that the two bladders BL1 and BL2 have a connecting seam VN1 and VN2 which, on the one hand, has the same shape and, for example, corresponds to the shape of the connecting seam of the bladder BL of FIG. 3. Moreover, the two bladders BL1 and BL2 are advantageously arranged in a congruent manner on top of one another in the empty state, as shown in FIG. 4, in order to have a shape which is as compact as possible but to permit the greatest possible actuating path and/or lifting path in the direction of the axis ZA when filled with pressure medium. It is assumed therefrom, in particular, that the axis ZA extends perpendicular to a plane E2 of the bladder BL1 and/or corresponding to the plane of the peripheral connecting seam VN1.

As in the above described single bladder, a pressure medium line DL2 is also provided, said pressure medium line being incorporated in the connecting seam VN1 of the first bladder BL1. The pressure medium line DL2, corresponding to the arrangement of FIG. 3, may in this case also allow pressure medium into the bladder BL1, so that the pressure medium flow is oriented away from the center and in this manner turbulent flows and thus flow noise are minimized.

If pressure medium is now introduced via the pressure medium line DL into the first bladder BL, the volume of both the first bladder BL1 and the second bladder BL2 increases, in particular in the direction of the arrow D as shown in FIG. 5. By this alteration to the volume of the two bladders BL1 and BL2, a pressure force and/or lifting force is produced in the direction of the arrow D which in the installed state in a vehicle seat may be used for altering the contour of the seat support surface. As may be seen in any case in FIG. 5, the contour of the welded seams VN1 and/or VN2 of the bladders BL1 and/or BL2 prevents constrictions and/or kinks from being produced on the bladder, whereby a long service life of the bladder is ensured as a control element and/or lifting element. Although in FIGS. 4 and 5 merely a double bladder is shown as a control element, it is also conceivable, as already mentioned, to produce triple or multiple bladders of similar construction.

Reference is now made to FIG. 6 in which a schematic view of a vehicle seat FZS is shown, provided with corresponding control elements SX1 to SX4. As visible in FIG. 6, the vehicle seat FZS (in particular the motor vehicle seat) comprises a seat surface SF on which a user is able to sit and a backrest RL against which the user is able to rest. The seat surface SF and the backrest RL are denoted as a whole as the seat support surface.

In a practical example of FIG. 6, the seat surface SF comprises two control elements SX1 and SX2 and the backrest RL comprises two control elements SX3 and SX4 for adjusting a contour of the respective surfaces, either for forming a corresponding support function (for example lumbar support) or for altering the contour of the respective support surfaces within the context of a massage program. The control elements SX1 to SX4 may be formed in this case according to the control elements described above in FIGS. 2 to 5. The control elements in the practical example are pneumatic control elements which may be filled by means of compressed air as pressure medium and are thus able to be altered in shape in order to exercise their control function i.e. a pressure perpendicular to the respective support surface, in the case of the control elements SX1 and SX2 upwards in the image plane and in the case of the control elements SX3 and SX4 obliquely to the left upwards. In this case, compressed air is produced by a compressor KO and is deflected via a valve arrangement VA with a plurality of valves via compressed air lines L1 to L4 selectively into the control elements SX1, SX2, SX3 and/or SX4, in order to actuate the control elements in a specific manner. The compressed air (as pressure medium) introduced into the control elements may then also be discharged again via the compressed air line L1 to L4, the valve arrangement VA and at that point via a compressed air outlet channel AL. By using the above described control elements (as for example shown in FIGS. 2 to 5) a vehicle seat FZS is thus able to be produced, having a reliable and long service life due to the increased kink stability of the control elements according to the embodiments according to the invention.

What is claimed is:

1. A control element for a vehicle seat, the control element comprising:
a bladder configured to be filled with a pressure medium, the bladder including a first film and a second film connected together along a connecting seam to form a bladder chamber,
wherein the connecting seam has a shape of a polygon with rounded corners and wherein sides connecting adjacent corners or the polygon are curved in a concave manner.

2. The control element of claim 1, wherein the polygon shape of the connecting seam is square or a rectangle.

3. The control element of claim 1, further comprising a pressure medium line configured to introduce the pressure medium into the bladder chamber, wherein the pressure medium line is incorporated between the first and second films at the connecting seam.

4. The control element of claim 3, wherein the pressure medium line is incorporated in the bladder chamber perpendicular to a tangent applied to a point of the connecting seam.

5. The control element of claim 3, further comprising a pressure medium orientation device configured to direct the pressure medium flow when the pressure medium enters the bladder chamber, wherein the pressure medium orientation device is designed to direct the pressure medium flow away from the center of the bladder.

6. The control element of claim 1, comprising a further bladder configured to be filled with a pressure medium and connected to the bladder via an overflow channel that originates from a bladder portion of the bladder.

7. The control element of claim 6, wherein the further bladder includes a further bladder first film and a further bladder second film connected together along a further bladder connecting seam to form a further bladder chamber, wherein the further bladder connecting seam has a shape of a polygon with rounded corners and wherein sides connecting adjacent corners or the polygon are curved in a concave manner.

8. The control element of claim 1, wherein the connecting seam is a welded seam.

9. The control element of claim 1, wherein the bladder is configured to be filled with a gaseous pressure medium.

10. A vehicle seat, comprising:
a seat support surface for a user; and
at least one control element arranged in the vehicle seat to alter the contour of the seat support surface, each of the at least one control element comprising:
a bladder configured to be filled with a pressure medium, the bladder including a first film and a second film connected together along a connecting seam to form a bladder chamber,
wherein the connecting seam has a shape of a polygon with rounded corners and wherein sides connecting adjacent corners or the polygon are curved in a concave manner.

11. The vehicle seat of claim 10, wherein for each control element, the polygon shape of the connecting seam is square or a rectangle.

12. The vehicle seat of claim 10, wherein each control element further comprises a pressure medium line configured to introduce the pressure medium into the bladder chamber, wherein the pressure medium line is incorporated between the first and second films at the connecting seam.

13. The vehicle seat of claim 12, wherein for each control element, the pressure medium line is incorporated in the bladder chamber perpendicular to a tangent applied to a point of the connecting seam.

14. The vehicle seat of claim 12, wherein each control element further comprises a pressure medium orientation device configured to direct the pressure medium flow when the pressure medium enters the bladder chamber, wherein the pressure medium orientation device is designed to direct the pressure medium flow away from the center of the bladder.

15. The vehicle seat of claim 10, wherein each control element further comprises a further bladder configured to be filled with a pressure medium and connected to the bladder via an overflow channel that originates from a bladder portion of the bladder.

16. The vehicle seat of claim 15, wherein for each control element, the further bladder includes a further bladder first film and a further bladder second film connected together along a further bladder connecting seam to form a further bladder chamber, wherein the further bladder connecting seam has a shape of a polygon with rounded corners and wherein sides connecting adjacent corners or the polygon are curved in a concave manner.

17. A method for producing a control element for a vehicle seat having the following steps:
providing a first film and a second film; and
connecting the first and second film together at a connecting seam to form a bladder chamber between the first and second films, wherein the connecting seam has a shape of a polygon with rounded corners and wherein sides of the polygon connecting adjacent corners are curved in a concave manner.

18. The method of claim 17, comprising:
arranging a pressure medium line between the first and one second films; and
introducing a pressure medium into the bladder chamber via the pressure medium line.
